(19) United States
(12) Patent Application Publication
(10) Pub. No.: US 2004/0149012 A1
(43) Pub. Date: Aug. 5, 2004

(54) Method of analyzing sample

(76) Inventor: Masanao Furukawa, Takaishi-shi (JP)

Correspondence Address: KANESAKA AND TAKEUCHI, Suite 2, 1423 Powhatan Street, Alexandria, VA, 22314, US

(21) Appl. No.: 10/761,350

(22) Filed: Jan. 22, 2004

Related U.S. Application Data
(63) Continuation of application No. 10/300,581, filed on Nov. 21, 2002, now abandoned.

(30) Foreign Application Priority Data
Jan. 10, 2002 (JP) 2002-003020

(51) Int. Cl. G01N 30/04

(52) U.S. Cl. 73/23.42

(57) ABSTRACT

In a method of analyzing a sample, an internal pressure of a sample chamber is maintained at a predetermined level through a control valve. When the sample is injected into the sample chamber, the control valve is held at an opening degree before the sample is injected into the sample chamber for a predetermined period of time. Thus, a substantial amount of the sample injected to the sample chamber can be sent to a detector without loosing through the control valve.

### CROSS REFERENCE TO RELATED APPLICATION

This is a continuation application of a patent application Ser. No. 10/300,581 filed on Nov. 21, 2002.

### BACKGROUND OF THE INVENTION AND RELATED ART STATEMENT

The invention relates to a. method of analyzing a sample using a gas chromatograph.

FIG. 3 shows an example of a structure of a sample vaporization chamber and peripherals of a conventional gas chromatograph.

Carrier gas is supplied to a sample vaporization chamber 4 through a carrier gas supply path 7 from a supply source, such as a gas bomb (not shown). Then, the carrier gas is supplied to a column 5 and a detector 6, and then discharged into the outside. A sample to be analyzed is injected into the sample vaporization chamber 4 through a sample injection port 41 by a syringe (not shown). The sample is separated into various components during the passage through the column 5 together with the carrier gas, and the detector 6 detects the components to thereby analyze them.

A split path 8 branched from the sample vaporization chamber 4 discharges a part of the carrier gas to the outside through a control valve 3 provided in the middle thereof. A quantity of the discharged gas is adjusted through an opening extent of the control valve 3, thereby controlling an internal pressure of the sample vaporization chamber 4.

In order to improve an analytical accuracy, it is important to control the internal pressure (column pressure) of the sample vaporization chamber 4 accurately. To this end, the conventional gas chromatograph includes a pressure sensor 2 for detecting the internal pressure of the sample vaporization chamber 4 and a control portion 1 for controlling the opening degree of the control valve 3. Accordingly, a closed loop control is carried out where an output value p of the pressure sensor 2 and a preset pressure value q are compared and the difference therebetween is brought closer to zero, thereby maintaining the internal pressure of the sample vaporization chamber 4 constant.

In the conventional gas chromatograph as described above, when a sample is injected, especially in a case that a large quantity of gas sample is injected in a short time, the internal pressure of the sample vaporization chamber 4 is suddenly increased. At this time, the closed loop control system, which detects the sudden increase in the internal pressure, operates to open the control valve 3 wide and lower the internal pressure. Therefore, a considerable amount of the injected gas sample escapes through the split path 8. Thus, quantitative accuracy of the analysis is lost. Also, the sample quantity to be analyzed is reduced, so it is difficult to detect a small quantity component.

Heretofore, in order to solve the problem, the gas sample is injected slowly so that the internal pressure in the sample vaporization chamber 4 increases gradually. In other words, an operator slowly pushes a plunger of a syringe for injecting the gas sample. For example, when 0.5 ml of a gas sample is injected, it takes about 10 seconds to push the plunger for injecting the gas sample to minimize the sudden pressure increase. Thus, it takes very long time to inject a large quantity of gas sample, resulting in poor workability and a burden for the operator.

In view of the above problems, the present invention has been made and an object of the invention is to provide a method of analyzing a sample using a gas chromatograph having a closed loop control system. In the method according to the invention, an internal pressure in a sample vaporization chamber is held constant by controlling a flow rate of the gas discharged through the split path. In the method according to the invention, even when the gas sample is injected rapidly, the gas sample is prevented from escaping through the split path, so that the workability can be improved and, at the same time, the quantitative accuracy and the sensitivity of a small quantity component are improved.

Further objects and advantages of the invention will be apparent from the following description of the invention.

### SUMMARY OF THE INVENTION

In order to attain the above objects, a gas chromatograph including a closed loop control system is operated such that a gas quantity discharged through a split path is controlled by a control valve to maintain a pressure in a gas sample vaporization chamber constant. According to the present invention, the closed loop control system is temporarily shut off after a gas sample is injected, and during the shut-off, the control valve is held at the same opening degree as that right before the closed loop control system is shut off. It is possible to inject the gas sample in a short time to thereby improve the workability. Further, it is possible to introduce substantially a whole quantity of the injected gas sample into the column, so that the quantitative accuracy and the sensitivity of a small quantity component can be improved.

### BRIEF DESCRIPTION OF THE DRAWINGS

FIG. 1 is a block diagram showing the first embodiment of a gas chromatograph according to the present invention;

FIG. 2 is a block diagram showing the second embodiment of a gas chromatograph according to the present invention; and

FIG. 3 is a block diagram showing a structure of a conventional gas chromatograph.

### DETAILED DESCRIPTION OF PREFERRED EMBODIMENTS

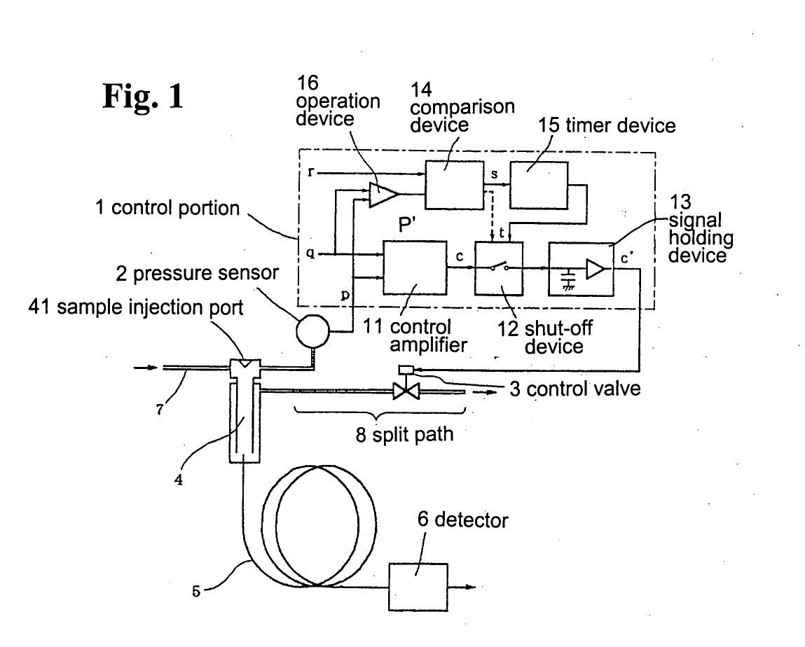

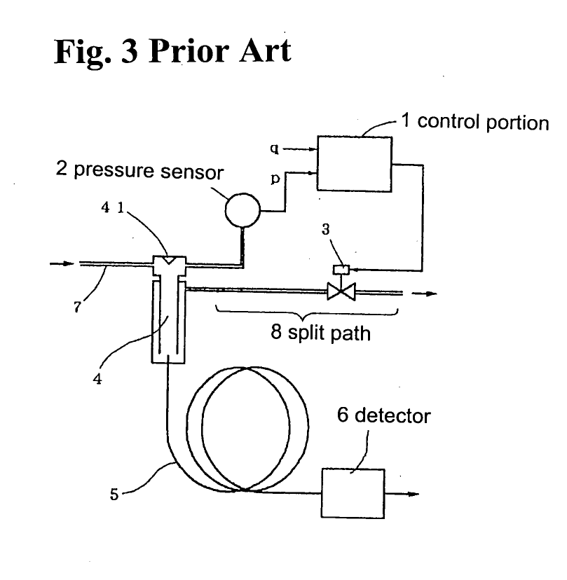

The first embodiment of the invention is shown in FIG. 1. In the drawing, since a flow path system where a carrier gas and a gas sample flow is the same as that of a conventional gas chromatograph as shown in FIG. 3, the explanation thereof is omitted.

In FIG. 1, a control amplifier 11 outputs a control signal c to compare an output value p of a pressure sensor 2 with a preset pressure value q so that a difference therebetween is minimized. A shut-off device 12 is formed of a switching element operated by an operation signal t for turning on and off the control signal c. A signal holding device 13 is a circuit structured to output a signal following the input signal (in this case, the control signal c) in a normal situation. When the input is shut off, the signal holding device 13 holds an input value as an output c′ right before the input is shut off. In the drawing, there is shown an analog holding circuit using a condenser for the sake of intuitive understanding. However, in an actual case, the signal holding device 13 is formed of a digital memory element.

An operation device 16 outputs an increased pressure portion p′, which is obtained by subtracting the preset pressure value q from the internal pressure p of the sample vaporization chamber 4. Then, a comparison device 14 sends an output signal s when the increased pressure portion p′ exceeds a preset threshold value r. A timer device 15 starts upon receiving the signal s to send a signal t, and continues to send the signal t for a predetermined time. The signal t becomes the afore-mentioned operation signal t to operate the shut-off device 12 so as to shut off the flow of the control signal c.

A control portion 1 structured as described above operates and controls the internal pressure of the sample vaporization chamber 4 as follows:

In a state where the sample is not injected, i.e. under a normal condition, a closed loop control system is established. That is, the control signal c output from the control amplifier 11 passes through the shut-off device 12 where the switching element is turned on, and the signal holding device 13, which outputs a signal following the input signal. Then, the control signal c is transmitted to the control valve 3 to control the internal pressure of the sample vaporization chamber 4 by changing an opening degree of the control valve 3. The change in the internal pressure is fed back to an input side of the control amplifier 11 through the pressure sensor 2. Thus, the control portion 1 accurately controls the internal pressure so that the internal pressure of the sample vaporization chamber 4 is maintained at a predetermined value in the same manner as in the prior art shown in FIG. 3.

During the above-stated state, when a large quantity of a gas sample is injected into the sample vaporization chamber 4 in a short time, the internal pressure in the sample vaporization chamber 4 is suddenly increased. The pressure sensor 2 detects the sudden increase in the internal pressure, and sends an output value p to the operation device 16 to obtain an increased pressure portion p′. When the increased pressure portion p′ exceeds the preset threshold value r, the comparison device 14 outputs a start signal s to start the timer device 15. An operation signal t is sent from the timer device 15 to operate the shut-off device 12 so that the closed loop control system is shut off.

After the closed loop control system is shut off, the opening degree of the control valve 3 is maintained at a certain value by an output c′ of the signal holding device 13 for holding a value of the control signal c right before the shut-off. The control valve 3 under this state holds substantially the same opening degree as in the normal state, and most of the injected gas sample flows toward a column 5 since the gas quantity discharged from a split path 8 is limited.

When a specific period of time set in the timer device 15 passes, the shut-off device 12 is restored to carry out the closed loop control. By this time, most of the injected gas sample flows toward the column 5 (the timer device 15 is set to operate such a way) so that even if the closed loop control is resumed, the gas sample does not escape. As a result, almost the whole quantity of the injected sample can be analyzed to thereby maintain the quantitative accuracy.

In a case that the gas sample is injected into the sample vaporization chamber 4 over a long period of time, or a liquid sample is injected (it takes a longer time to vaporize the liquid sample in the sample vaporization chamber 4 and increase the internal pressure), the pressure increasing rate in the sample vaporization chamber 4 is small. Thus, the closed loop control system starts operating before the increased pressure portion p′ reaches the threshold value r to thereby lower the pressure. Accordingly, the internal pressure of the sample vaporization chamber 4 does not increase, and the shut-off device 12 does not operate. In other words, in this case, the operation of the gas chromatograph according to the present invention is exactly the same as that of the prior art.

In a case that the large quantity of sample is injected quickly as described before, it is necessary that the shut-off device 12 operates before the closed loop control system operates corresponding to the increase in the pressure to start opening the control valve 3. Accordingly, it is necessary to shorten a response time of the signal path composing of the pressure sensor 2, operation device 16, comparison device 14, timer device 15 and shut-off device 12. To this end, a differential function may be added to the operation device 16 so that a sum of an increase rate of the pressure and the increased pressure portion is outputted as the value p′. As a result, it is possible to operate the shut-off device 12 based on a certain estimate of the increase rate of the pressure, thereby shortening the response time of the signal path.

In the above-described embodiment according to the present invention, it is important to set the timer device 15 properly. When the set time is too short, the closed loop control is resumed even if the sample is still in the sample vaporization chamber 4, and the remaining sample is discharged. On the other hand, when the set time is too long, the analysis takes place in a state where the internal pressure (a column top pressure) in the sample vaporization chamber 4 is not controlled, thereby affecting the analysis accuracy negatively. Accordingly, the timer device 15 needs to be set at an appropriate value after trial and error, which is somehow troublesome.

In order to eliminate this problem, it is also possible to structure such that an output of the comparison device 14 is used as an operation signal t for operating the shut-off device 12, not through the timer device 15, as shown by hidden line in FIG. 1. In this case, during a period when the increased pressure portion p′ in the sample vaporization chamber 4 is higher than the threshold value r, the shut-off device 12 operates to lock the control valve 3 at a lower opening degree. After the internal pressure in the sample vaporization chamber 4 returns to a value close to the normal value and the lock is released, the analysis is carried out under the accurately controlled column pressure.

When an automated sampler is used to inject the sample automatically, a start signal for injecting the sample and, at the same time, a start signal for measuring a retention time are outputted from the auto-sampler. Thus, it is also possible to use the start signal as a start signal s for starting the timer device 15 in the present invention.

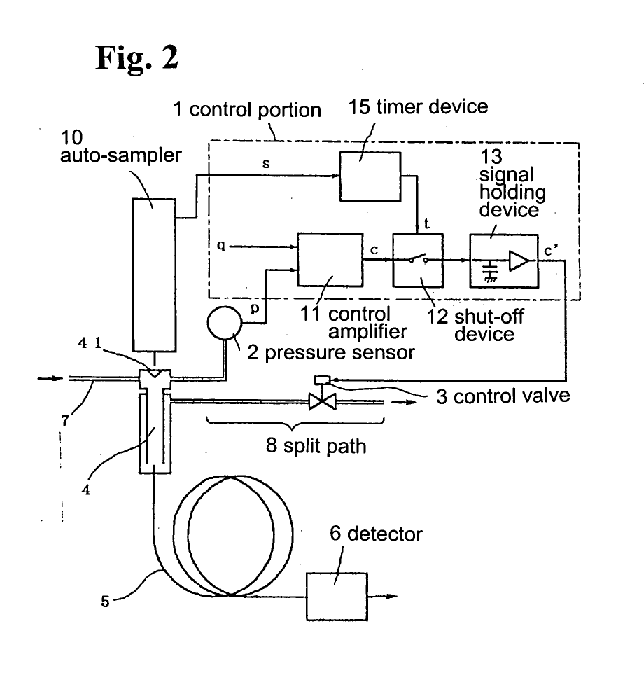

FIG. 2 shows the second embodiment of the invention structured as described above. The structural elements except an auto-sampler 10 in the drawing are the same as those in FIG. 1.

In FIG. 2, a sample is injected through a sample injection port 41 by the auto-sampler 10 and, at the same time, a start signal s is sent. The timer device 15 starts operating upon receiving the signal s. Operations thereafter are the same as those of the first embodiment shown in FIG. 1.

The structure of the control portion 1 of the second embodiment shown in FIG. 2 is simple and performs a reliable operation. However, the embodiment is limited to a case where a start signal can be obtained from an external device, such as an auto-sampler.

The control portions of the invention, as shown in FIGS. 1 and 2, are devices, each being formed of combined circuit blocks having such functions as operation, amplification, retention, comparison and timer. However, the control portion may also be a device wherein the above-stated functions are executed according to an appropriate program by a computer like software.

Also, the operation device 16, as shown in FIG. 1, can be omitted depending on the threshold value r. Therefore, the operation device 16 is not an essential element for constituting the present invention.

Since the present invention is structured as described above, even if the gas sample is injected quickly, the sample loses only a small quantity by escaping through the split path. According to an experiment, as compared with a case where 0.5 ml of a gas sample was slowly injected for ten seconds, when the same quantity of the gas sample was quickly injected for one second using the apparatus according to the present invention, quantitative sample retention was about 95%. In contrast, an apparatus of the prior art showed less than 50%. In other words, in the apparatus of the invention, even when the gas sample is injected quickly, the loss of sample quantity is in the order of 5%. Thus, according to the present invention, it is possible to quickly inject the sample without losing the quantitative accuracy and detecting sensitivity to thereby improve workability.

While the invention has been explained with reference to the specific embodiments of the invention, the explanation is illustrative and the invention is limited only by the appended claims.

What is claimed is:

1. A method of analyzing a sample, comprising:
maintaining an internal pressure of a sample chamber at a predetermined level through a control valve,
injecting the sample into the sample chamber,
holding the control valve at an opening degree before the sample is injected into the sample chamber for a predetermined period of time so that a substantial amount of the sample injected to the sample chamber can be sent to a detector without loosing through the control valve.

2. A method of analyzing a sample according to claim 1, further comprising maintaining the internal pressure at the predetermined level again after the predetermined period of time.

3. A method of analyzing a sample according to claim 2, further comprising:
detecting an increment in the internal pressure upon injecting the sample into the sample chamber,
comparing the increment with a predetermined threshold, and
holding the control valve at the opening degree before the sample is injected when the increment exceeds the predetermined threshold.

4. A method of analyzing a sample according to claim 3, wherein said control valve is maintained at the predetermined level by a closed loop control through detections of the control valve and the internal pressure of the sample chamber.

5. A method of analyzing a sample according to claim 4, wherein when said increment exceeds the predetermined threshold, a timer is started to shut off the closed loop control for said predetermined period of time.

6. A method of analyzing a sample according to claim 3, wherein when the increment in the sample chamber is detected, pressure increase in the sample chamber is expected with reference to a speed thereof to thereby quickly actuate the control valve.

7. A method of analyzing a sample according to claim 1, wherein said sample is automatically injected with an auto-sampler, and the internal pressure in the sample chamber is directly compared with the predetermined threshold to control the control valve.

8. A method of analyzing a sample according to claim 1, wherein said sample is automatically injected with an auto-sampler, and upon actuation of the auto-sampler, the control valve is held for the predetermined time at said opening degree.
